(19) United States
(12) Patent Application Publication
(10) Pub. No.: US 2014/0111014 A1
(43) Pub. Date: Apr. 24, 2014

(54) CHARGING AND DISCHARGING SYSTEM AND METHOD FOR BATTERY

(71) Applicant: Hon Hai Precision Industry Co., Ltd., New Taipei (TW)

(72) Inventors: HSIANG-PIN TSENG, New Taipei (TW); MIN-WEI LEE, New Taipei (TW)

(21) Appl. No.: 13/917,490

(22) Filed: Jun. 13, 2013

(30) Foreign Application Priority Data
Oct. 23, 2012 (TW) 101138991

(51) Int. Cl. H02J 7/00

(52) U.S. Cl. CPC H02J 7/0029
USPC 307/66

(57) ABSTRACT

A charging and discharging system for a battery includes an adapter, a charging controller, a converting module, and a battery. The adapter receives an AC voltage, converts the AC voltage to a DC voltage, and electrically connects the charging controller to the converting module. When the adapter is supplying power, the charging controller can switch on and switch off the converting module, and the converting module accordingly connects and disconnects the adapter to or from the battery. When the adapter is not supplying power, the battery provides power for the electronic device. Therefore, the battery is electrically isolated from the adapter and can be protected from a sudden power surge when the adapter is powered on.

### BACKGROUND

1. Technical Field

The present disclosure relates to a charging and discharging system and method for a battery.

2. Description of Related Art

Electronic devices such as mobile phones and notebooks may include a storage battery. Usually, an adapter converts an AC voltage to a DC voltage which is directly provided to the storage battery in a charging process. However, there is a loss of power in the storage battery. The loss of power is calculated by a ratio between a voltage input and a voltage output. The adapter may also generate an instant high current that destroys the storage battery when the adapter is powered on. Therefore there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a system for charging and discharging the battery of an electronic device.

FIG. 2 is a flow chart of one embodiment of a method for charging and discharging the battery of an electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

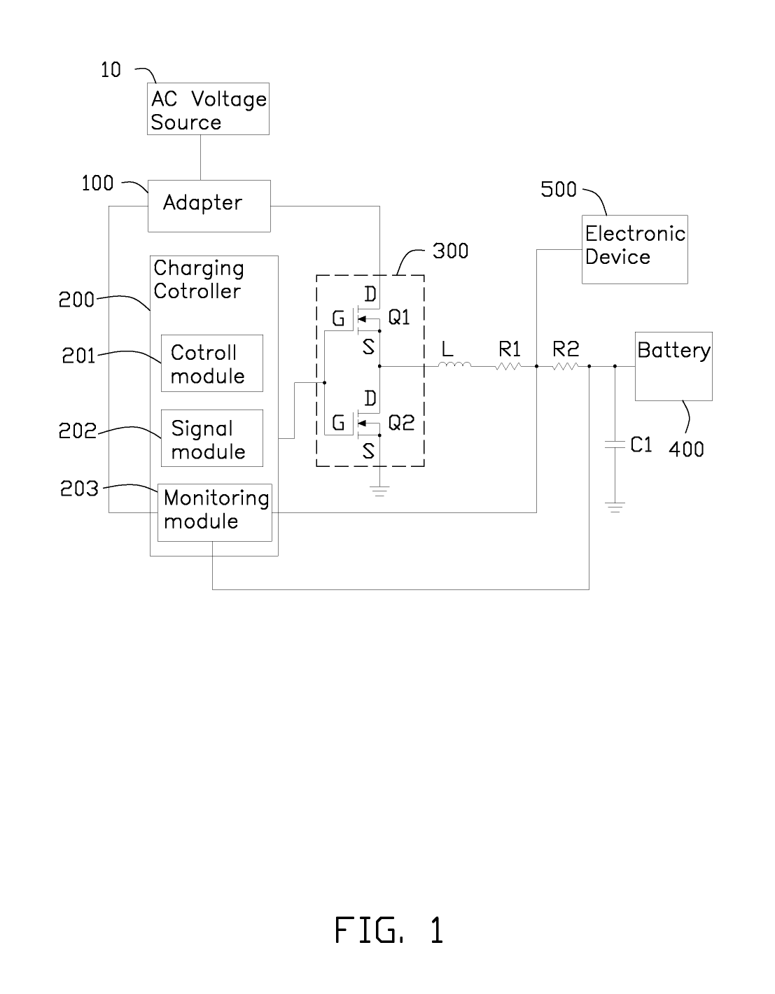

FIG. 1 illustrates a block diagram of a charging and discharging system in accordance with one embodiment. The system includes an AC (alternating current) voltage source 10, an adapter 100, a charging controller 200, a converting module 300, a battery 400, and an electronic device 500. The adapter 100 is adapted to receive an AC voltage from the AC voltage source 10 and convert the AC voltage into a direct current (DC) voltage. The adapter 100 charges the battery 400 and provides power for the electronic device 500.

The charging controller 200 includes a control module 201, a signal module 202, and a monitoring module 203.

The converting module 300 includes a first field-effect transistor Q1 and a second field-effect transistor Q2, electrically connected to the first field-effect transistor Q1. A gate electrode of both the first field-effect transistor Q1 and the second field-effect transistor Q2 is connected to the signal module 202 of the charging controller 200. The first field-effect transistor Q1 drain electrode is electrically connected to the adapter 100. The first field-effect transistor Q1 source electrode is electrically connected to the second field-effect transistor Q2 drain electrode and connected to a first end of an inductance L. The second field-effect Q2 source electrode is grounded. A second end of the inductance L is electrically connected to a first end of a first resistance R1. The second end of the first resistance R1 is connected to the monitoring module 203, a first end of a second resistance R2, and the electronic device 500.

The battery 400 is electrically connected to a second end of the second resistance R2 and a first end of a capacitance C1. A second end of the capacitor C1 is grounded.

In use, the AC voltage source 10 provides power for the adapter 100, and the monitoring module 203 monitors the adapter 100, when supplying power and sends a charging signal to the control module 201. The control module 201 controls the signal module 202 to send a digital-high signal to the converting module 300. The first field-effect transistor Q1 and the second field-effect transistor Q2 are switched on, and the adapter 100 charges the battery 400 and provides power for the electronic device 500. The monitoring module 203 monitors an input current passing through the second resistance R2 and sends the input current value to the control module 201. When the input current value is greater than a predetermined high current value, the control module 201 controls the signal module 202 to send a digital-low signal to the converting module 300. The first field-effect transistor Q1 and the second field-effect transistor Q2 are switched off. The battery 400 provides power for the electronic device 500 through the second resistance R2. The monitoring module 203 monitors an output current passing through the second resistance R2 and sends the output current value to the control module 201. When the output current value is lower than a predetermined low current value, the control module 201 controls the signal module 202 to send the digital-high signal to the first field-effect transistor Q1 and the second field-effect transistor Q2. The adapter 100 charges the battery 400 and provides power for the electronic device 500 again.

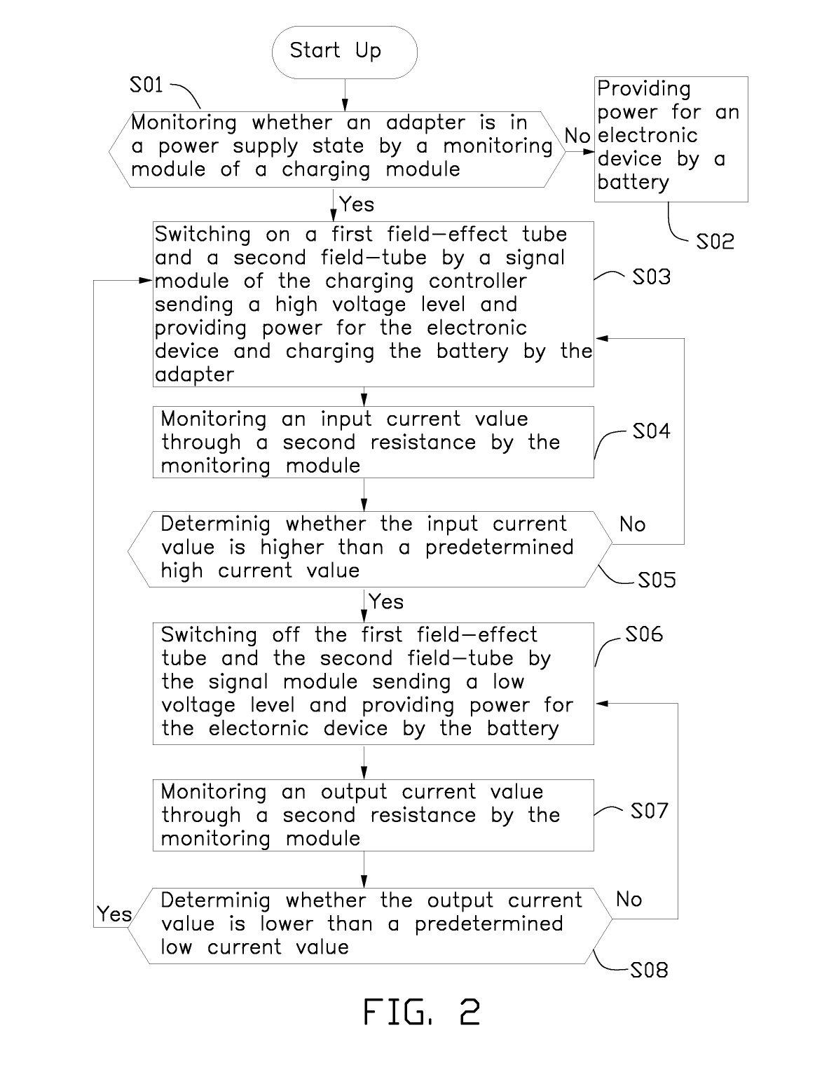

FIG. 2 is a flowchart showing one embodiment of a charging and discharging method using the charging and discharging system of FIG. 1. The method comprises the following steps:

In step S01: the monitoring module 203 of the charging controller 200 monitors whether the adapter 100 is supplying power. When the adapter 100 is supplying power, the flow goes to step S03. When the adapter 100 is not supplying power, the flow goes to step S02.

In step S02: the battery 400 provides power for the electronic device 500.

In step S03: the control module 201 controls the signal module 202 to send the digital-high signal to the converting module 300. The first field-effect transistor Q1 and the second field-effect transistor Q2 are switched on to electrically connect the adapter 100 to the electronic device 500 and the battery 400, and the adapter 100 provides power for the electronic device 500 and charges the battery 400.

In step S04: the monitoring module 203 monitors the input current through the second resistance R2 and sends the input current value to the control module 201.

In step S05: the control module 201 determines whether the input current value is higher than the predetermined high current value. When the input current value is higher than the predetermined high current value, the flow goes to step S06. When not, the flow goes to step S03.

In step S06: the control module 201 controls the signal module 202 to send a digital-low signal to the converting module 300, and the first field-effect transistor Q1 and the second field-effect transistor Q2 are switched off. The battery 400 provides power for the electronic device 500.

In step S07: the monitoring module 203 monitors the output current to the resistance R2 and sends the output current value to the control module 201.

In step S08: the control module 201 determines whether the output current value is lower than the predetermined low current value. When the output current value is lower than the predetermined low current value, the flow goes to step S03. When not, the flow goes to step S06.

In the charging and discharging system, the battery 400 is not directly connected to the adapter 100. Therefore, the battery 400 cannot be destroyed by a sudden high current generated by the adapter 100 when the adapter 100 is powered on.

Even though numerous characteristics and advantages of the present disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A charging and discharging system comprising:
an adapter being adapted to receive an alternating current (AC) and convert the AC to a direct current (DC);
a charging controller electrically connected to the adapter;
a converting module electrically connected to the adapter; and
a battery electrically connected to the converting module,
wherein the charging controller is electrically connected to the adapter and the converting module; when the adapter is in a power supply state, the charging controller is adapted to send a signal to switch on/off the converting module, and the converting module is adapted to connect/disconnect the adapter with the battery and an electronic device; and when the adapter is not in the power supply state, the battery is adapted to provide power for the electronic device.

2. The charging and discharging system of claim 1, wherein the converting module comprises a first field-effect transistor and a second field-effect transistor; the first field-effect transistor drain electrode is electrically connected to the adapter, the first field-effect transistor grid electrode and the second field-effect transistor grid electrode are connected to the charging controller, the first field-effect transistor source electrode is electrically connected to the second field-effect transistor drain electrode, and the second field-effect transistor source electrode is grounded.

3. The charging and discharging system of claim 2, further comprises an inductance and a first resistance connected to the inductance in series, wherein the inductance is electrically connected to the source electrode of the first field-effect transistor and the drain electrode of the second field-effect transistor, and the first resistance is electrically connected to the electronic device and the battery.

4. The charging and discharging system of claim 3, further comprising a second resistance, wherein a first end of the second resistance is electrically connected to the first resistance and the electronic device, and a second end of the second resistance is electrically connected to the battery.

5. The charging and discharging system of claim 4, further comprising a capacitor, wherein a first end of the capacitor is electrically connected to the second resistance and the battery, and a second end of the capacitor is grounded.

6. The charging and discharging system of claim 4, wherein the charging controller comprises a control module and a signal module, the control module is configured to control the signal module to send the signal to switch on/off the first field-effect transistor and the second field-effect transistor when the adapter is in the power supply state.

7. The charging and discharging system of claim 6, wherein the charging controller further comprises a monitoring module; the monitoring module is adapted to monitor the adapter power supply state, an input current value through the second resistance, and an output current value through the second resistance; and the signal module is adapted to send a digital-high signal to switch on the first field-effect transistor and the second field-effect transistor when the adapter is in the power supply state.

8. The charging and discharging system of claim 7, wherein the control module is adapted to determine whether the input current value is greater than a predetermined high current value when the adapter is in the power supply state, when the input current value is greater than the predetermined high current value, the signal module is adapted to send a digital-low signal to switch off the first field-effect transistor and the second field-effect transistor, and the battery provides power for the electronic device; when not, the adapter provides power for the electronic device and charges the battery.

9. The charging and discharging system of claim 8, wherein the control module is adapted to determine whether the output current value is lower than a predetermined low current value when the adapter is not in the power supply state; when the output current value is lower than the predetermined low current value, the signal module is adapted to send a digital-high signal to switch on the first field-effect transistor and the second field-effect transistor, and the adapter provides power for the electronic device and charges the battery; when not, the battery provides power for the electronic device.

10. A charging and discharging battery method, the method comprising:
monitoring whether a adapter is in a power supply state by a charging controller;
sending a signal to switch on/off a converting module to connect/disconnect the adapter with an electronic device and a battery by the charging controller when the adapter is in the charging state; and
providing power for the electronic device by the battery when the adapter is not in the power supply state.

11. The charging and discharging method of claim 10, wherein the converting module comprises a first field-effect transistor and a second field-effect transistor; the first field-effect transistor drain electrode is electrically connected to the adapter, the first field-effect transistor grid electrode and the second field-effect transistor grid electrode are connected to the charging controller, the first field-effect transistor source electrode is electrically connected to the second field-effect transistor drain electrode, and the second field-effect transistor source electrode is grounded.

12. The charging and discharging method of claim 11, wherein the first field-effect transistor source electrode and the second field-effect transistor drain electrode are electrically connected to an inductance, and the inductance is electrically connected to a first resistance in series.

13. The charging and discharging method of claim 12, wherein the first resistance is electrically connected to a first end of a second resistance and the electronic device, and a second end of the second resistance is electrically connected to the battery and a first end of a capacitor, and a second end of the capacitor is grounded.

14. The charging and discharging method of claim 13, wherein the sending the signal to switch on/off the converting module to connect/disconnect the adapter with the electronic device and the battery by the charging controller when the adapter is in the power supply state comprises:
switching on a first filed-effect transistor and the second field-effect transistor by a signal module of the charging controller sending a digital-high signal to the first field-effect transistor and the second field-effect transistor;
monitoring an input current value through the second resistance by a monitoring module of the charging controller;
determining whether the input current value is greater than a predetermined high current value by a control module of the charging controller; when the input current value is higher than the predetermined high current value, the signal module sends a digital-low signal to switch off the first field-effect transistor and the second field-effect transistor, and the battery provides power for the electronic device; when not, the adapter provides power for the electronic device and charges the battery.

15. The charging and discharging method of claim 14, wherein the sending the signal to switch on/off the converting module to connect/disconnect the adapter with the electronic device and the battery by the charging controller when the adapter is in the power supply state further comprises:
monitoring an output current value through the second resistance by the monitoring module;
determining whether the output current value is lower than a predetermined low current value by the control module; when the output current value is lower than the predetermined low current value, the signal module sends a digital-high signal to switch on the first field-effect transistor and the second field-effect transistor, and the adapter charges the battery and provides power for the electronic device; if not, the battery provides power for the electronic device.
